(19) United States
(12) Patent Application Publication
(10) Pub. No.: US 2005/0104853 A1
(43) Pub. Date: May 19, 2005

(54) Mechanical motion sensor and low-power trigger circuit

(76) Inventors: Chatree Sitalasai, La Crescenta, CA (US); Toshisada Takeda, Simi Valley, CA (US); Dean Larry Rice JR., Simi Valley, CA (US); John Guo, Oak Park, CA (US); Charles Lee Fauble, Queen Creek, AZ (US)

Correspondence Address: SCHULTE ROTH & ZABEL LLP;ATTN: JOEL E. LUTZKER, 919 THIRD AVENUE, NEW YORK, NY, 10022, US

(21) Appl. No.: 10/714,095

(22) Filed: Nov. 13, 2003

(51) Int. Cl. G09G 5/08

(52) U.S. Cl. 345/163; 340/686.1; 200/61.45 R

(57) ABSTRACT

A wake-up system for an input device having a circuit board inside it has a motion sensor mounted on the printed circuit board inside the input device. The motion sensor has a motion signal output and the wake-up system further include a detection circuit connected to the motion signal output. The detection circuit has a wake-up signal output. The input device can be an optical wireless mouse. The motion sensor may be a mechanical motion sensor such as a tilt sensor having a ball contact and stationary contacts. The stationary contacts may be printed directly on the printed circuit board. The ball contact and stationary contacts form an electrical switch and are gold-plated. The ball contact is conductive. The motion sensor may be sealed to avoid corrosion. The detection circuit detects a change of state of whether the electrical switch formed by the ball contact and stationary contact is opened or closed. A first embodiment can amplify the motion signal from the motion sensor and a second embodiment can detect a low signal from the motion sensor. Also disclosed is a method of waking up an input device such as a mouse and an input device comprising the wake-up system.

### FIELD OF THE INVENTION

This invention relates to a system for generating a trigger signal such as a wake-up system for a mouse. More specifically, the invention relates to a sensor for determining when a device such as a mouse is in use and a wake-up circuit that permits power conservation.

### BACKGROUND OF THE INVENTION

A wireless mouse consumes considerable power which reduces the battery life. An optical mouse does not include moving parts that could otherwise be used to detect when a user moves or shakes a mouse in order to wake it up so that the mouse may have a sleep-mode and a wake mode for reducing power consumption. In the Microsoft Optical Mouse, a capacitance switch or hand sensor detects when a human hand is on the mouse for operation. However, the microprocessor continues to consume power to search for whether a hand is on the mouse or not, even in the sleep mode. Such a capacitance switch uses 250 to 350 μ amps of current even in the sleep mode. A small change of capacitance is detected in the order of 2-3 picofarads. An oscillator is needed at all times to scan for the change in capacitance.

Cursor controller sleep mode systems are known. U.S. patent Application Nos. 2003/0074587; 2002/0126094; U.S. Pat. Nos. 5,990,868; 5,729,009; 5,812,085 and 5,874,942 fall in this category. Of these, 2003/0074587, 2002/0126094 and U.S. Pat. No. 5,812,085 involve capacitive detection elements.

The Casebolt, et al. Patent Application Publication No. U.S. 2003/0074587 is assigned to Microsoft Corporation and is directed to a capacitive sensing and data input device power management system. The Casebolt Patent Application relates to power management systems used in managing power consumption in electronic devices and particularly hand-operated data input devices. Battery power is conserved in wireless data input devices. Cursor control (pointing) devices such as a computer mouse and a trackball device have been made wireless by inclusion of a battery power source within the device and the provision of a wireless data link. The Casebolt Application further acknowledges that cursor control devices utilizing optical surface tracking systems have been introduced and are increasingly being used in lieu of devices relying on conventional opto-electric encoder wheel arrangements. Optical tracking requires considerably more power for driving the circuitry used to illuminate a trackball surface and to receive and process light reflected from the trackball surface. Multiple sleep and awake modes are utilized to increase battery life. Switching from a full run mode through a succession of reduced power modes is carried out based upon durations of user inactivity. Whenever the user moves the mouse or clicks a mouse button, the mouse returns to the full run mode. In the Casebolt Application, a capacitive sensing system and method is employed to reliably and efficiently sense the presence or absence of an object or body portion in contact with or close proximity to the data input device.

The Casebolt Patent Application includes a capacitive sensing system inside the housing of an electronic device which senses the presence of something in contact with or close proximity to the electronic device and generates a signal with an ON state when there is something in contact with or in close proximity to the electronic device and generates an OFF state when there is nothing in contact with or in close proximity to the electronic device. In the active state, each of the mouse sub-systems is powered-up and fully operational. The active state only occurs at times when the sensing algorithm generates an ON state indicating the presence of a user's hand on or in close proximity to the mouse. The absence of a user's hand results in generation of an OFF flag. Upon a determined duration of mouse inactivity in the active state, coupled with an ON state of the sensing algorithm, the state machine transitions to an idle state. In the idle state, the system cycles between the shut down and active state conditions. Upon occurrence of an OFF signal, the state machine transitions from the idle state to the shut down state. Alternatively, if no mouse movement occurs for another period of time such as 30 seconds, the state machine transitions to an extended idle state. Just as in the idle state, in the extended idle state, the system cycles between the shut down and active state conditions but with a longer period of shut down per cycle. There is also a beacon state indicating that the mouse has been picked up off of its supporting surface by the user in which case, the tracking light source is flashed at a reduced rate. FIG. 7 is a schematic of a capacitive proximity sensing system.

The Junod Patent Application Publication No. U.S. 2002/0126094 is directed to an input device with a capacitive antenna. A hand held detection circuit is provided which uses the antenna for detecting the proximity of a user's hand to the housing of the input device and producing a hand detect signal in response. A sleep mode is provided for the electronic circuitry to conserve power. The hand detect signal will awaken the input device from its sleep mode. The input device may be a pointing device such as a mouse. A wireless mouse uses batteries and an antenna to transmit to a receiving unit connected to a computer. One strategy to limit power consumption is the activity monitoring approach. In the activity monitoring approach some monitoring activity is started in a periodic manner to verify that a user is not soliciting the device in any way. If activity is detected, the device resumes an active state. In this approach, battery saving is obtained due to the long idle time between two activity monitoring periods. Additionally, there is an interrupt approach which relies on the interrupt input found in the device micro controller. This input, when asserted, activates built-in wake-up circuitry that brings the device back to an active mode from an idle state in which power consumption is less. When the device is idle, the wake-up circuitry is active and requires an amount of power. In this configuration, the input interrupt is connected to a switch that the user must depress to activate and wake-up the device.

Junod recognizes that the problem of power consumption is particularly troublesome in new mice using an optical module which detects the reflection of light off a surface to determine mouse movement. When such a device is wireless, it is difficult to have batteries that can last more than a couple of months. A hand detection device may use a capacitive detection. FIGS. 2A, 2B, 5, 6 and 7 show the capacitive structures for detecting the presence of a human hand on a mouse.

The Frederick Patent (U.S. Pat. No. 5,990,868) is directed to an apparatus for performing power conservation in a pointing device located on a wireless data entry device. The wireless remote control input device includes a trackball. The device further includes a power management means for managing the power of the power source by monitoring the status and activity of the trackball used on the remote control input device. FIG. 4 illustrates a flow chart for the operation of the power management system. The power management means includes an active monitoring means that checks the trackball activity continually. The power management includes several sleep levels. The device selects the sleep level based on the amount of time the device has been idle. The pre-selected levels are three levels that are, 1) whether the trackball has been left idle for more than twenty seconds, 2) whether the trackball has been idle for more than 10 minutes, or 3) whether the trackball has been idle for more than 30 minutes. Based on the particular level of idleness, the system powers down the micro device. The method of operating the device determines whether the trackball pointing device is active, idle or asleep, then selects a level based on the period of idleness of the trackball pointing device, and then reduces the power used by the remote controller by curtailing monitoring of the trackball pointing device according to the sleep level. The method automatically determines the activity of the trackball pointing device by sensing user input or by determining that a button has been pressed.

The Dandliker Patent (U.S. Pat. No. 5,729,009) is directed to a method for generating quasi-sinusoidal signals for optical pointing devices for use with personal computers. The most common form of pointing device is the electronic mouse and the second most common is the trackball. Most electronic mice use a mechanical approach in which a ball is on the underside of the mouse and rolls over the reference surface such as a desktop when the mouse is moved.

Optical mice are different. FIG. 7A is a flow chart for the operation of a mouse or other pointing device. The processing determines whether a sleep mode is appropriate, and if yes, the electronics go into sleep mode until a displacement is detected in a periodic interrupt routine or a time out occurs. If not, the processing determines whether the mouse is moving. If not, sleep mode is enabled. If the mouse is moving, the displacement is computed.

The Barraza Patent (U.S. Pat. No. 5,812,085) is directed to a remote control device for operating a controlled device such as a TV, computer PC, VCR or digital satellite system. The hand held control device such as an air mouse is provided with a microprocessor. In order to conserve battery power, the microprocessor may be switched from a high power awake state in which the air mouse functions are performed and a low power sleep state. Power is conserved through the use of conductive outer surfaces that form a switch that controls the awake/sleep state of the microprocessor. The holding of the remote control device in the hand of a user with a finger on a conductive control button awakens the microprocessor. The microprocessor enters the sleep state once the user hand is removed from its operating position on the remote control device.

The Walker Patent (U.S. Pat. No. 5,874,942) is directed to sensor data processing. A system for processing data originating from a joy stick type device using attitude sensing is disclosed. The device has automatic power reduction. The sensor data may be produced from a mouse type device. Firmware embedded in the processor performs the function of power management including AutoSleep. Redundancy analysis of the sensor data is a prime factor in overall power consumption reduction. Briefly, if successive data samples are redundant, there is no obligation to transmit the redundant sample. Non-redundant data will deactivate the redundancy mode. Various modes of different levels are employed. The level 4 mode is only activated after extreme redundancies are detected. Extreme periods are in the order of 5 to 10 minutes, implying that the operator has finished usage of the device. This mode is termed AutoSleep, and obviates the necessity for an off switch, with its implicit obligation that the operator remembers to use it appropriately. When the device is asleep, the micro controller is in halt mode, which reduces its current consumption. All other components are already powered down due to previous redundancy levels having been reached. A control signal from a Fire button instigates an interrupt to the micro controller, causing it to go through a wake-up procedure which re-powers all other circuitry.

Motion/tilt detectors with conductive ball structures are known. U.S. Pat. Nos./Application Nos. 6,339,199; 6,087,936; 5,837,951; 4,766,275; 5,209,343; 4,293,860; 3,752,945; 3,619,524; and 5,030,955 fall in this category.

The Chou Patent (U.S. Pat. No. 6,339,199) is directed to a tilt switch which includes a central electric contact member which defines a rolling area. An electrically conductive ball member is rollable on the rolling area. An electrically conductive shell member confines a space for the ball member. There is a first electric contact terminal and the electrically conductive shell has a second electric contact terminal in electric contact with the first electric contact terminal. When the rolling area is tilted, the ball member moves by virtue of gravity to contact with the inner surface of the shell member so as to establish an electrical connection between the central electric contact member and the first electric contact terminal. The tilt switch is mounted on a support 30 such as the circuit board. The central electric contact member is shown as reference numeral 32 in FIG. 1. The electrically conductive ball member 20 is made of copper material and is rollable on the rolling surface of the central electric contact member 32. The first electric contact terminal is shown as reference numeral 311 (FIG. 2) and there are two such terminals. The electrically conductive shell member 10 has a pair of second electric contact terminals 17 shown in FIG. 3. An electrically conductive solder material 40 is disposed to interconnect electrically the terminal leg 14 of the second electric contact terminal 17 with the first electric contact terminal 311. Once the rolling area is tilted from the horizontal plane, the ball member 20 moves by virtue of gravity to contact with the inner peripheral surface 122 so as to establish an electrical connection between the central electric contact member 32 and the first electric contact terminal 311.

The Woods Patent (U.S. Pat. No. 6,087,936) is directed to a vibration sensor that distinguishes between various causes of vibrations. The vibration sensor includes an electrically-conductive ball within a chamber for movement therein. The ball simultaneously contacts at least one of spaced electrically-conducted contacts and an electrode so that the ball connects the first and second terminals of a vibration monitoring system to allow an electrical signal to be transmitted between the terminals. As the ball moves in the chamber, it contacts different ones of the contacts. The vibration sensor not only senses the opening and/or closing of a contact by a ball, but also other characteristics such as the position, velocity and trajectory of the ball and the time that it takes for the ball to return to its equilibrium position. Thus, the magnitude, duration and/or other characteristics of vibrations to distinguish between various causes of the vibration, is determined, reducing false alarms.

The Kato Patent (U.S. Pat. No. 5,837,951) is directed to an inertia switching device and acceleration responsive device for use with an automatic shut off valve having an integrated microcomputer and employed in acidic gas equipment and commercial propane gas equipment or mounted on control devices of oil space heaters, gas burning appliances and electrical equipment, for detecting oscillations such as an earthquake to supply a detection signal to the automatic shut off valve or control device. Thus, the device of the Kato patent is a seismosensitive device. The seismosensitive device comprises a housing 2 and a header 3 formed of an electrically conductive material such as a metal. A contact plate 7 serves as a fixed contact and is secured on one end of the terminal pin 6. The contact plate 7 has a plurality of feather portions 7A regularly extending from its center and having sufficient elasticity. An electrically conductive solid inertial ball 8 serves as a movable contact and is enclosed in the housing 2. The bottom 2A of the housing 2 includes an inclined face. The inclined face is a conical face obtained by turning a straight line with an inclination 2C shown in the FIG. 1. The bottom face 2B of the housing 2 is provided with a central recess 2A serving as a rest portion for holding the inertia ball 8 in position until it is subject to an oscillation with a predetermined magnitude. In operation, the inertia ball rests on the recess when it is stationary at its normal attitude. In this state, the inertia ball 8 is positioned apart from the contact plate. When subjected to an oscillation, the inertia ball 8 is kept resting on the recess 2A until the predetermined oscillation acceleration intensity value depending on the radii of the inertia ball and the recess is reached. When the predetermined oscillation acceleration intensity value is reached, the inertia ball 8 is caused to move out of the recess 2A, rolling on the bottom face 2B of the housing 2. Rolling on the bottom face 2B, the inertia ball comes into contact with the feather portions 7A of the contact plate 7. Consequently, an electrical path is made by the terminal pin 6, the contact plate 7, the inertia ball 8, the housing 2 and the header 3. A resultant electrical signal is supplied to various warning devices or control devices such that a protective device such as an automatic shut off valve or a control device of a gas burning appliance is operated to prevent occurrence of a fire due to an earthquake. In an embodiment shown in FIG. 22, the contact plate and the feather portions are below the ball 49 rather than above the ball.

The Hemann Patent (U.S. Pat. No. 4,766,275) is a motion sensing switch wherein a conductive ball is movable within a cavity defined by a base member defining a cylindrical cavity and a closure member to make and break electrical contact between top and bottom contact members of a first potential and sidewall contact of another potential.

The Romano Patent (U.S. Pat. No. 5,209,343) is directed to an electrical tilt switch. The tilt switch has at least one conductive weight which moves freely within the housing. The weight abuts against terminals as it moves and electricity is conducted through the weight from one terminal to the other, thus completing a circuit. The free moving weight may be a rounded weight such as a single metal ball. The conductive balls 30 may be fabricated from a high density material such as lead, steel or the like, and may include a plating such as copper, nickel or gold to increase surface conductivity. The housing 12 is filled with an inert gas 32 such as nitrogen, neon or the like. The inert gas 32 provides a non-corrosive environment for the conductive balls 30 preventing oxidation, pitting and other corrosion common to electrical contacts. A non-corrosive environment can be formed within the housing by evacuating the housing of all gases or filling the housing with a low viscosity non-conductive liquid such as silicon oil.

The Iwata Patent (U.S. Pat. No. 4,293,860) is directed to an antenna alarm assembly for a vehicle. The assembly is provided with an alarm to protect the antenna mounted on a vehicle such as a car from theft. The assembly includes a vibration detector which electrically detects any vibration and an alarm circuit which operates to produce an alarm in response to detection of vibration applied to the casing of the antenna or the car body. The vibration detector includes a printed circuit board which is placed on the bottom plate of the casing and which is formed with a first and a second electrode. The vibration detector also includes a conductive spherical body 36 which is placed on the printed circuit board in a rollable manner. When the spherical body moves over the printed circuit board in response to vibration applied to the casing, the circuit connection across the power supply is repeatedly turned on and off to produce a pulse signal which operates the alarm circuit. The first and second electrodes and the ball 36 constitute together the vibration detector.

The Achterberg Patent (U.S. Pat. No. 3,752,945) is directed to an electrical alternating contact switch which produces switching impulses by inclining and rotating the switch. There is an electrically conductive ring with a pyramidally tapered inner surface, a cover plate and a rolling ball which can be released by tilting the switch so as to roll between the surfaces presented by the ring and the cover plate. The ball 4 is made of a conductive material and provides the electrical contact means.

The Gillund Patent (U.S. Pat. No. 3,619,524) is directed to a sensor. The sensor includes a cylindrical housing having an apertured planer base wall and a contact plate. A magnet is mounted on the base wall and located normal to the aperture. The magnetic flux of the magnet maintains a ball in a seated relationship with a ball seat provided by the opening of the apertured plate. The magnet is shown by reference numeral 22. The ball 28 is of a magnetic electrically conductive material. A circumferential series of adjacent spaced axially tapered spring fingers 36 extend generally radially of the ring 34 and of the ball seat 26. The proximal portions of the spring fingers are integrally joined to ring 34 at portion 38 and cantilever the fingers in overlying angularly spaced relationship to the surface 30.

The Durst Patent (U.S. Pat. No. 5,030,955) is directed to a remote controlled transmitter with a function selector device which includes an optically functioning tilt switch which selects the function. The remote control transmitter can be used to move a curser up and down in a vertical direction and to and fro in a horizontal direction on the screen of a television set. The tilt switch device is located in the housing and emits four different selection signals depending upon the tilt of the housing: forward, backwards, to the left, and to the right. With reference to FIG. 3, there is a recess 20. At the edges of the recess 20, there is a narrow contact element 22 and to the right and left of this a wider contact element contact 23. A ball 24, better shown in FIGS. 4a and 4b, has a surface 25 that is highly electrically conductive. The ball typically rests on the middle contact element 22. When the remote control transmitter is tilted in one of the directions, the ball will roll along the edges and the ball will connect the two contact elements 23.

Circuitry for motion detectors is disclosed in U.S. Pat. Nos./Application Nos. 5,493,538; 4,980,575; 4,688,025; 4,196,429; 3,742,478; 3,733,447 and 2002/0014971.

The Bergman Patent (U.S. Pat. No. 5,493,538) is directed to a transition detection circuit. A latch circuit is set by a detection circuit which detects a difference between inputs. One of the inputs is delayed by a predetermined period of time. The output of the latch circuit is inverted and delayed through a delay circuit and resets the latch circuit. FIG. 9 illustrates a delay circuit.

The Schenkel Patent (U.S. Pat. No. 4,980,575) is directed to a motion sensor and detection system. Detection circuitry illustrated in FIG. 7 is associated with a sensor to provide an electrical output indication of the sensing of motion of the structure on which the sensor and the detection circuitry are disposed. The sensor is shown as reference numerals 32, 34, 36 and 38. When the elements 36 and 38 are making contact with one another, line 52 is electrically connected to the negative terminal of the battery. When the elements are separated, the line 52 voltage level is pulled up to the battery voltage V+ through resistor 54 which has a very large resistance value so that the current through the resistor is minimized when line 52 is grounded. When the motion sensor is at rest, the elements 36 and 38 are stationary and will either be in contact or be separated from one another. Therefore, line 52 will be at a constant voltage level (ground or V+). When there is movement, the elements will be in random motion, sometimes making contact and sometimes separated. This will cause line 52 to toggle between V+ and ground. The system includes for motion detection a transition detector 56, a latch 58, a timer 60 and an analog switch 62. The system is furnished with a clock signal over line 64.

The Frank Patent (U.S. Pat. No. 4,688,025) is directed to a movement sensor. FIG. 5 illustrates the movement sensor 100 which comprises of a cylindrical container formed of a circular cross section sidewall 102 and two end walls 104, only one of which is shown in FIG. 5. The closed container houses a ball 106 made of conductive material. The side wall 102 is made of a conductive material or alternatively, has a conductive layer on its surface. Each of the end walls 104 has on its inner surface electrically conductive regions 108 and 110. The region 108 has the shape of a ring with a plurality of radially and inwardly extending contact arms 112. The region 110 is shaped as an inner ring having a plurality of radially outwardly extending contact arms 114 which are interdigitated with the arms 112. The ball 106 will rest with one part of its surface contacting the sidewalls 102 and another part touching either one of the arms 112 or 114, or the space between a pair of such arms. Movement of the sensor 100 will cause the ball to roll, while maintaining contact with the side wall 102 so that the ball 106 successfully touches respective arms 112 and 114. The sensor operates in any plane. FIG. 2 is a schematic diagram of the movement sensor circuit. FIG. 3 shows a delay circuit which can be used in FIG. 2 for delay circuits 22, 24 and 36.

The Davis Patent (U.S. Pat. No. 4,196,429) is directed to a motion detector. An array of interdigitally related elements are interstitially spaced from one another, with alternate elements in the array connected to a first conductor and the remaining elements in the array connected to a second conductor. A conductive member, such as a metallic ball, is freely moveable in two dimensions, over the area of the array, electrically coupling and decoupling adjacent elements in the array as it moves. A circuit is connected between the first and second conductors and detects the coupling of and/or decoupling of electrical contacts between adjacent elements as the ball moves over the elements. Further, the circuitry detects the frequency of the coupling and/or decoupling being detected to indicate a predetermined motion or absence of motion. FIG. 10 is a schematic view of the sensing circuitry used with the motion detector. The circuit shown in FIG. 10 incorporates a circuit, commonly known as a “hex inverter” buffer amplifier circuit. Sensitivity is determined by special relationship of the ball and the conductor width and separation.

The Johnson Patent (U.S. Pat. No. 3,742,478) is directed to a circuit board motion sensitive switch. The motion sensitive switch includes a steel ball positioned to roll freely across the surface of a printed circuit board having three separate circuits positioned thereon in a space relationship such as shown in FIG. 4. If the switch is moved even slightly, the steel ball rolls from circuit to circuit making and breaking connections so as to sound an alarm. In addition, a circuit is shown in FIG. 5. An alarm is sounded only upon the steel ball, contacting two of the circuits so as to charge a capacitor and then the ball rolls into contact with a different pair of circuits so as to discharge the capacitor into an alarm relay 42. The motion sensitive switch causes a capacitor 32 to be charged. Any disturbance of switch board 14 which then causes the ball to roll to a new position in which it establishes contact between circuits 27 and 26 allows capacitor 32 to discharge into circuit 26. Current in circuit 26 is presented to the gate of the silicon controlled rectifier 38 so as to make silicon controlled rectifier 38 conducting. Current is passed through silicon controlled rectifiers 36 and 38 to the relay 42 which in turn activates a radio transmitter to send a signal to a remote alarm station having a suitable radio receiver.

The Schneider, Jr. Patent (U.S. Pat. No. 3,733,447) is directed to a tilt responsive inertia switch with a printed circuit and a moveable ball contact. The switch includes a conducting ball which moves when the switch is tilted. The ball momentarily closes the contact terminal means. FIG. 1 is a plan view of a printed circuit board switch with contact terminals. The printed circuit board disk 10 has etched or deposited thereon pie shaped conductive contact terminals sections 11, 11a, 11b, 11c, 11d, 11e, 11f and 11g. These pie shaped conducts are separated and insulated from each other by radial channels 12. A surface 13a is electrically connected to contact terminals 11a, 11c, 11e and 11g by a connecting wire 14. A second surface 13b is connected to contact terminals 11b, 11d, 11f and 11 by a common conductor 15. A pair of pie shaped segmented printed circuit boards are connected in parallel and spaced from each other by an insulated circular track. On each of the two circuit boards electrical conductors are connected to adjacent pie shaped segments. A conductive ball is located intermediate to the two parallel segmented sections.

The Ferraro Patent Application Publication No. U.S. 2002/0014971 is directed to a flood light lamp removal orientation alarm. The lights are designed to turn on automatically if a motion detector is triggered and the ambient light level is low. Further, if any of the flood light lamps and sockets are moved out of position, the event is detected. FIG. 7 shows an alarm triggering circuit with sensor switches S3 and S4. The triggering circuit detects any attempted tampering. The alarm 122 stays on for a period of time determined by the delay interval timer 124. Further, an indicator lamp or light emitting diode (LED) remains on until manually turned off indicating that the alarm 122 has been triggered. A signal conditioning circuit for the two sensor switches consists of the resistor R1, capacitor C2 and a Schmidt trigger inverter.

FIG. 14 shows a hardware implementation of a motion detector which functions by detecting a transition state of either or both tilt switches 801 or 802 which are single pole single throw regardless of their initial state (open or close). The event is stored in a flip-flop and is used to set an alarm.

### SUMMARY OF THE INVENTION

It is an object of the invention to provide a system for a device having a printed circuit board inside it, which is capable of sensing motion to generate a trigger signal.

It is another object of the invention to provide a wake-up system for an input such as a mouse which reduces power consumption and significantly improves battery life.

A further object of the invention is to provide an input device such as a wireless optical mouse with a mechanical motion sensor and low power wake-up circuit.

It is an object of the invention to provide a motion sensor and wake-up circuit for use with an input device that uses less than 10μ amps of current in the sleep mode.

It is still a further object of the invention to provide a motion sensor that is very sensitive and can detect very rapid opening and closing of an electrical switch in the order of 10 ns or more.

Additionally, it is an object of the invention to provide a wake-up system that is a static device which detects the changing state of an electrical switch from open to closed or closed to open.

It is another object of the invention to provide a wake-up system that can be used with an optical mouse which does not include moving parts that could otherwise be used to detect when a user moves or shakes the mouse in order to wake it up.

It is still a further object of the invention to provide a wake-up system that includes a very small motion sensor that is placed directly inside the mouse and mounted on the printed circuit board.

It is an additional object of the invention to provide a wake-up system for an input device that is not subject to corrosion.

It is a still further object of the invention to provide a wake-up system where the sensitivity of a motion sensor is adjustable during manufacture.

These and other objects of the invention are accomplished by providing a system for a device having a printed circuit board inside it, comprising: a motion sensor mounted on the printed circuit board inside the input device, the motion sensor having a motion signal output; and a detection circuit connected to the motion signal output and having a trigger signal output. The system may be a wake-up system and the device may be an input device. The trigger signal output may be a wake-up signal output.

In a preferred embodiment, there is provided a mechanical motion sensor.

In another preferred embodiment, there is provided an input device comprising: a printed circuit board; a motion sensor mounted inside the input device on the printed circuit board, the motion sensor having a motion signal output; and a detection circuit responsive to the motion signal and having a wake-up signal output.

The invention contemplates a method of waking up an input device having a printed circuit board inside it, comprising: mounting a motion sensor directly on the printed circuit board; outputting a motion signal from the motion sensor; providing a detection circuit responsive to the motion signal; and outputting a wake-up signal from the detection circuit to circuitry of the input device to wake-up the input device.

The above and other objects, aspects, features and advantages of the invention will be more readily apparent from the description of the preferred embodiments thereof taken in conjunction with the accompanying drawings and appended claims.

### BRIEF DESCRIPTION OF THE DRAWINGS

The invention is illustrated by way of example and not limitation in the figures of the accompanying drawings in which like references denote like and corresponding parts and in which:

FIG. 1 is a cross sectional diagram of a motion sensor in accordance with the present invention;

FIG. 2A is a partial cross-sectional diagram showing the position of a conductive ball contact of the motion sensor of FIG. 1 where a closed circuit is established;

FIG. 2B is a partial cross-sectional diagram of the motion sensor of FIGS. 1 and 2A showing the position of the conductive ball contact when there is an open circuit;

FIG. 3 is a cross-sectional diagram of the motion sensor where there is no hole in the PCB mounting the stationary contact in accordance with a second embodiment of the present invention;

FIG. 4A is a partial cross-sectional diagram of the motion sensor of FIG. 3 showing the conductive ball contact in a position to establish a closed circuit;

FIG. 4B is a partial cross-sectional diagram of the motion sensor of FIGS. 3 and 4A showing the position of the conductive ball contact when there is an open circuit;

FIG. 5 is a top view of the motion sensor in accordance with the present invention showing how the cross sections of FIGS. 1 thru 4B are taken;

FIG. 6 comprises four figures:

FIG. 6A shows the contact pattern for the stationary contacts where there are two stationary contacts;

FIG. 6B shows the contact pattern where there are four stationary contacts;

FIG. 6C shows the contact pattern where there are six stationary contacts;

FIG. 6D shows the contact pattern where there are eight stationary contacts;

FIG. 7 shows the wake-up system including a motion sensor and detection circuit, including a motion detector and a signal processing circuit in accordance with a first embodiment of the invention; and

FIG. 8 shows a second embodiment of the motion detector of the detection circuit.

### DESCRIPTION OF THE PREFERRED EMBODIMENTS

The invention is a mechanical motion sensor and low power wake-up circuit for use in an input device such as a wireless optical mouse which reduces power consumption and significantly improves battery life. The present invention saves current consumption compared to the prior art hand sensor capacitance switch when in the sleep mode. As set forth above, such a prior art capacitance switch uses up 250 to 350 μamps of current even in the sleep mode. In contrast, the present invention uses only 5-8 μamps in the sleep mode. Thus, battery life is extended.

Referring to FIG. 7, a wake-up system for an input device having a printed circuit board inside it is shown in accordance with the first embodiment of the invention. The wake-up system includes a motion sensor 1 which is mounted on the printed circuit board inside the input device such as a mouse. The input device may be an optical wireless mouse.

The motion sensor has a motion signal output 2. The wake-up system further includes a detection circuit 3 which is connected to the motion signal output. Further, the detection circuit 3 has a trigger signal output. In the embodiment shown, the trigger signal output is wake-up signal output 4.

FIG. 1 shows the motion sensor 1. FIG. 1 is a cross-sectional view of the motion sensor which is taken along Line A-A of FIG. 5. FIG. 1 shows a sensor housing 5 which houses a conductive ball contact 6. The housing 5 is mounted on the printed circuit board 7 of the input device such as an optical wireless mouse. The printed circuit board 7 has mounted directly on it a stationary contact 8. As illustrated, the stationary contact 8 and the printed circuit board 7 have a hole 9 in them which helps to position the conductive ball contact 6 for a closed circuit. The housing 5 of the motion sensor is sealed to the printed circuit board 7. As illustrated, the sealing comprises an O-ring. However, any type of effective sealing that keeps out moisture may be employed. Thus, sealing by use of an adhesive may be employed alternatively.

The surfaces of the stationary contact 8 and/or printed circuit board 7 may be inclined to further help position the conductive ball contact for a closed circuit. The angle of inclination is not shown in FIG. 1.

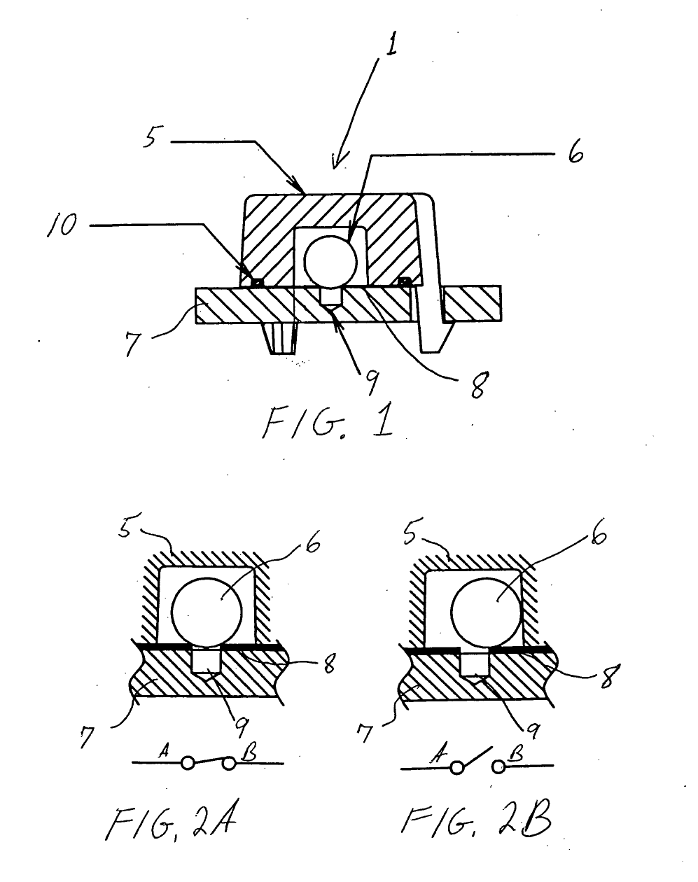

FIGS. 2A and 2B are partial cross-sectional diagrams of the motion sensor of FIG. 1 showing the position of the conductive ball contact in the closed and open circuit positions. More particularly, FIG. 2A shows the position of the conductive ball contact when there is an closed circuit between the terminal A and B shown in FIG. 7. In contrast, FIG. 2B shows the position of the conductive ball contact when there is an open circuit between the terminals A and B in FIG. 7.

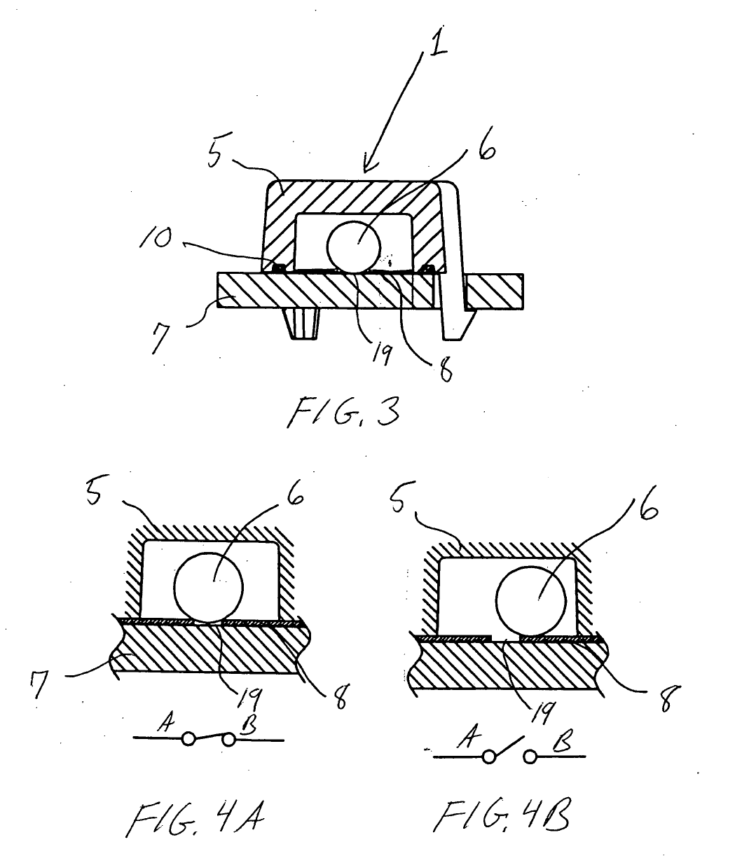

FIG. 3 is a cross-sectional view of the motion sensor of another embodiment of the present invention. The embodiment shown in FIG. 3 differs from that shown in FIG. 1 in that there is no hole in the printed circuit board 7. There is an aperture 19 in the stationary contact 8. The surface of the stationary contact and/or printed circuit board 7 may be inclined towards the center of the motion sensor to help position the conductive ball contact for a closed circuit. The angle of inclination is not shown.

FIGS. 4A and 4B are partial cross-sectional diagrams of the motion sensor of FIG. 3 showing the position of the conductive ball contact in the closed and open circuit positions. More particularly, FIG. 4A shows the position of the conductive ball contact when there is an closed circuit between the terminal A and B shown in FIG. 7. In contrast, FIG. 4B shows the position of the conductive ball contact when there is an open circuit between the terminals A and B in FIG. 7.

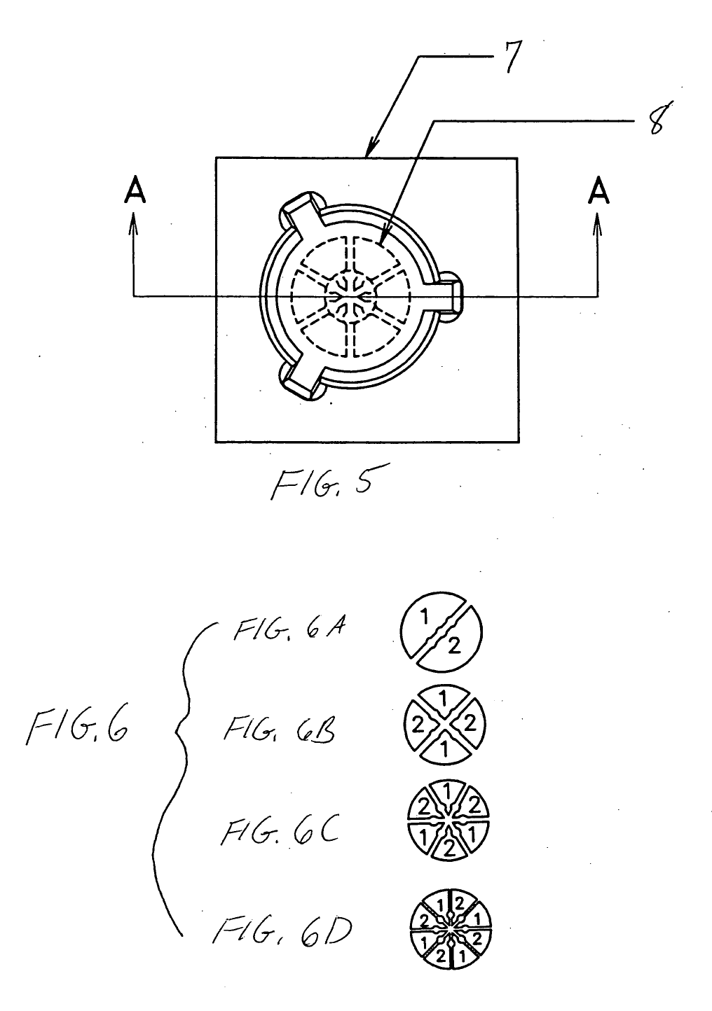

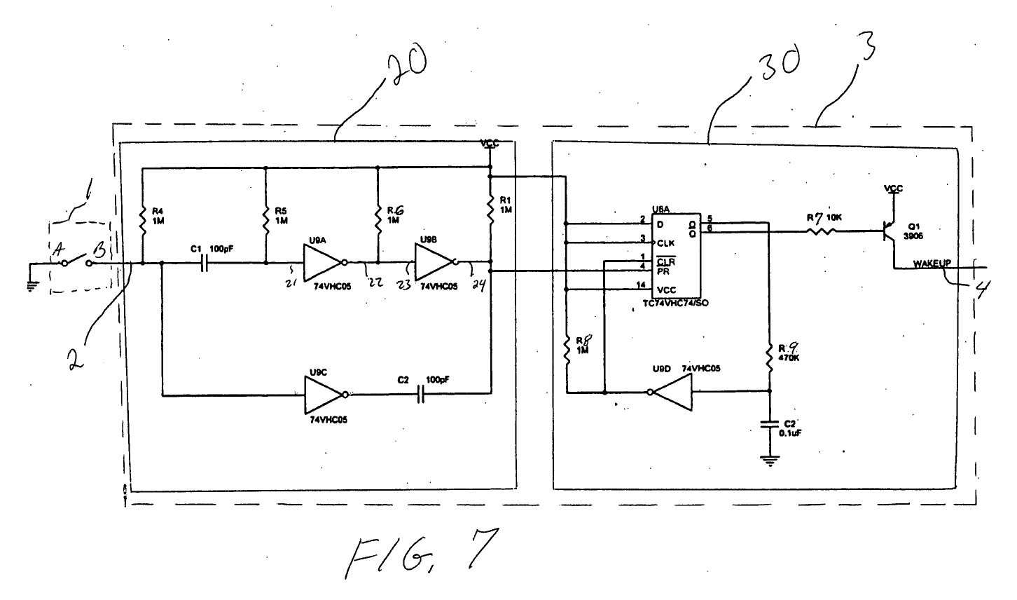

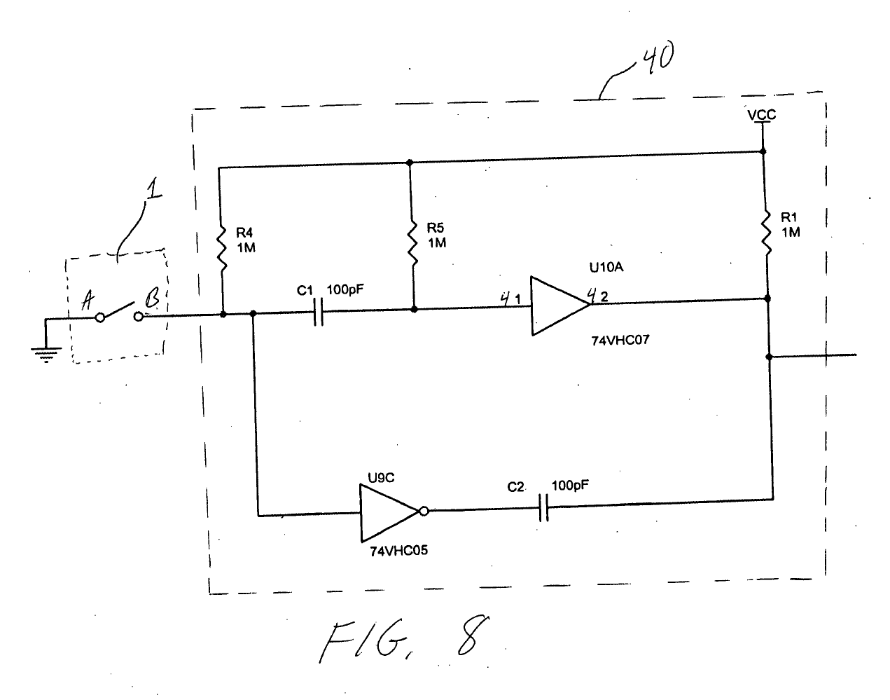

FIG. 5 shows a plan view of the motion sensor 1 of the present invention. The motion sensor is mounted directly upon the printed circuit board of the mouse or other input device. As shown by hashed lines, the pattern of the stationary contact may be seen. The pattern is discussed in more detail with reference to FIG. 6. The cross-sectional diagrams of FIGS. 1, 2A, 2B, 3, 4A, and 4B are taken along Line A-A of FIG. 5.

FIG. 6 shows the pattern of the stationary contacts and contact polarity. Each of the contacts shown in FIG. 6, regardless of polarity 1 or 2, constitute the terminal B shown in FIG. 7 for the motion sensor 1. There may be any number of stationary contacts connected to the terminal B of the motion sensor. FIG. 6 illustrates four variations having respectively 2, 4, 6 and 8 stationary contacts arranged in a circle like the pieces of a pie. In FIG. 6A, there are two stationary contacts. In FIG. 6B, there are four stationary contacts. In FIG. 6C, there are six stationary contacts. In FIG. 6D, there are eight stationary contacts. The embodiments of the motion sensor shown in FIG. 1 and FIG. 3 may have any of the variations of the contacts patterns shown in FIG. 6. The more stationary contacts in the sensor contact pattern, the more sensitive the sensor is. However, the size of the sensor may be effected if more stationary contacts are desired.

The motion sensor 1 of the present invention may be as small as a grain of rice or much larger. In one prototype, the motion sensor 1 is one-quarter inch in diameter. The motion sensor 1 is placed directly on the PCB inside the mouse and thus, must be small.

The present invention is a tiny motion sensor with a ball contact 6. More particularly, there is a conductive ball contact 6 and a stationary contact 8 on the PCB in the mouse. The housing 5 of the motion sensor 1 is sealed. An electrical switch formed of the conductive ball contact 7 and the stationary contact 8 is opened and closed in accordance with a small force applied by the user's motions. A change in state of whether the switch is opened or closed is detected by the circuit illustrated in FIG. 7. A spike that is created as the switch opens and closes is referred to as wake-up noise which is recognized. A wake-up signal 4 is generated and the microprocessor of the input device wakes up the input device. The motion sensor 1 may have a hole in the center that the conductive ball contact 6 fits in as shown in FIGS. 1, 2A and 2B or the contact plate 8 may simply have an aperture 19 as shown in FIGS. 3, 4A and 4B. The motion sensor 1 will operate properly even if the mouse is located on an inclined surface.

The sensitivity of the motion sensor 1 may be adjusted. In many circumstances a mouse may be located next to other equipment which causes a vibration. Under these circumstances it is desirable that the mouse will not detect this motion and go into active mode because this would consume power unnecessarily. Thus, it is desirable that this type of vibration not be sensed. Accordingly, the sensitivity of the motion sensor 1 must be adjusted during manufacture to respond to the appropriate type of vibration associated with a user moving the mouse up and down or right to left or shaking it in order to wake up the mouse. The sensitivity may be adjusted by adjusting the size of the hole (9 or 19), the size of the ball contact 6, the weight or mass of the ball contact 6, the inclination of the stationary contacts 8 or the conductivity of the ball contact 6.

The conductive ball contact 6 is preferably a gold-plated metal ball. Any conductive material should generally work. Tests have indicated that pure copper is not sensitive enough to get the spikes to be detected to indicate that the mouse is being woken up and is not the preferred material. Finally, corrosive problems have been identified with copper and brass (65% copper and 35% tin). The motion sensor 1 further includes a gold plated copper sensor stationary contact located directly on the printed circuit board of the mouse. The housing 5 for the motion sensor 1 is sealed. As shown in FIGS. 1 and 3, there is a rubber O-ring. However, any type of sealing such as an adhesive may be used. The sealing is needed in order to eliminate dust and moisture. Moisture causes corrosion problems. Thus, a sealed housing 5 and a gold-plated metal ball contact 6 and a gold-plated sensor stationary contact are preferable.

As shown in FIG. 7, the motion sensor 1 outputs a motion signal at the motion signal output 2. A detection circuit 3 receives the signal from the motion signal output and generates a wake-up signal which is putout at output 4. The detection circuit 3 detects a change in the state of whether an electrical switch comprising the conductive ball contact 6 and the stationary contact 8 of the motion sensor 1 is opened or closed. More particularly, the detection circuit 3 is made of a motion detector 20 and a signal processing circuit 30. The motion detector 20 determines if there is a change in the opened or closed state of the motion sensor switch 1. The signal processing circuit 30 includes a latch circuit that creates a signal of a particular level such as a low pulse for a particular time period which is used to wake-up the microprocessor and thus, to wake-up the device. The circuit is very sensitive. Even a very rapid opening or closing of the motion sensor switch in the order of 10 ns or more, is detected. The circuit uses very little power because it is a static device when the switch is not changing state (opening or closing). If the switch is closed, it uses a small amount of power since there is a small amount of current drain through a resistor R4. Overall, the circuit uses less than 8 μ amps of current which is far less than any current mouse wake up circuit on the market. This is important in preserving the battery life. In the static condition, such as a mouse sitting on the desktop overnight, the circuit is very effective for preserving battery life.

The motion detector 20 of the detection circuit 3 is comprised of two inverters U9A and U9B in series. Further, a resister structure consisting of resistors R4, R5, R6 and R1 are pulled up to the voltage supply VCC. Further, a capacitor C1 is employed. These components make up the top portion of the motion detector 20. The motion detector 20 further has a bottom portion consisting of the inverter U9C and the capacitor C2. The top portion of the diagram is for detecting when the electrical switch closes and the bottom portion of the diagram is for detecting when the switch opens. More particularly, when the switch is closed the ultimate result is that there is a low voltage at the output terminal 24 of the second inverter U9B. The low signal is input on the line PR to the latch U6A of the signal processing circuit 30. In more detail, when the motion sensor 1 switch is closed, the capacitor C1 is drained and the input terminal 21 of inverter U9A goes low. Consequently, the terminal 22 of inverter U9A goes high and the input terminal 23 of the inverter U9B goes high generating a low output at the terminal 24 of inverter U9B. The capacitance C1 stops the draining of current and the output of inverter U9B at terminal 24 goes high. Thus, the terminal PR of latch U6A of the signal processing circuit 30 goes high again.

The bottom of the motion detector 20 operates in reverse when the motion sensor switch opens. More particularly, when the switch opens the input terminal PR to the latch U6A of the signal processing circuit 30 goes low and the output Q of latch U6A goes high, but only for a short time. The resistor R9 is attached to the inverted output Q. The capacitor C2 fills up and the input PR goes back high and a steady state is achieved without drawing of current. The transistor Q1 of the signal processing circuit 30 responds to the output Q of the latch U6A to invert the pulse to create a wake-up signal. In other words, when the Q output signal from the latch U6A is a high pulse, the output from the transistor Q1 is a low pulse.

Both inverters 9A-D are on a single package.

FIG. 8 illustrates an alternative motion detector of the detection circuit 3. The alternative motion detector 40 has fewer inverters than the motion detector 20 shown in FIG. 7. The motion detector 40 is for a mouse circuit design that can detect a low signal in contrast to the motion detector 20 of FIG. 7 which is for a mouse circuit design that needs signal processing for amplifying and converting a pulse. The motion detector 40 of FIG. 8 is used in conjunction with a signal processing circuit 30 such as shown in FIG. 7.

The motion detector 40 of FIG. 8 includes a top portion that has an inverter U10A with input terminal 41 and output terminal 42. The top portion of the motion detector 40 further includes resistors R4, R5 and R1 pulled up to the voltage supply VCC. Additionally, there is the capacitor C1 in series with the inverter U10A. The output of the circuit is from the output terminal 42 of the inverter U10A. The motion detector 40 also has a bottom portion which includes inverter U9C and capacitor C2.

The wake-up circuit can wake-up a microprocessor or wake-up a DC-DC converter, among other devices. In one implementation, the wake-up circuit may be built into a DC-DC converter and is able to “enable” or wake-up the DC-DC converter. The DC-DC converter then supplies power to a microprocessor, waking it up. If the microprocessor is to go asleep again, it disables the DC-DC converter, thus cutting off its own power supply. The motion sensor and detection circuit can wake it up again.

The present invention contemplates an input device such as a mouse comprising the wake-up system with motion sensor discussed. Further, the inventive concept contemplates a method of waking up an input device such as a mouse having a printed circuit board inside it. The method involved mounting a motion sensor directly on a printed circuit board of an input device. Outputting a motion signal from the motion sensor, providing a detection circuit responsive to the motion signal, and outputting a wake-up signal to circuitry of the input device to wake-up the input device. The method further contemplates the input device comprised of a microprocessor and the microprocessor waking up the input device in response to the wake-up signal from the detection circuit.

Although the invention has been described with reference to the preferred embodiment, it will be apparent to one unskilled in the art that variations and modifications are contemplated within the spirit and scope of the invention. The trigger signal output may be used to trigger an event other than waking-up a circuit or microprocessor. It may turn something on or off. The device may be a device other than an input device such as a remote control device. The drawings and descriptions of the preferred embodiments are made by way of example rather than to limit the scope of the invention, and it is intended to cover within the spirit and scope of the invention all such changes and modifications.

1. A system for a device having a printed circuit board inside it, comprising:
a motion sensor mounted on said printed circuit board inside said device, said motion sensor having a motion signal output; and
a detection circuit connected to said motion signal output and having a trigger signal output.

2. The system of claim 1, wherein said system is a wake-up system.

3. The wake-up system of claim 2, wherein said trigger signal output is a wake-up signal output.

4. The wake-up system of claim 2, wherein said device is an input device.

5. The system of claim 1, wherein said motion sensor is a mechanical motion sensor.

6. The system of claim 5, wherein said motion sensor is a tilt sensor.

7. The wake-up system of claim 4, wherein said input device is a mouse.

8. The wake-up system of claim 7, wherein said mouse is an optical mouse.

9. The wake-up system of claim 4, wherein said input device is wireless.

10. The system of claim 6, wherein said tilt sensor comprises an electrical switch comprised of:
a ball contact; and
at least one stationary contact on said printed circuit board.

11. The system of claim 10, wherein said stationary contact is printed on said printed circuit board.

12. The system of claim 10, wherein said stationary contact has a hole in the center.

13. The system of claim 10, wherein the stationary contact has an inclined surface toward its center.

14. The system of claim 10, wherein the sensitivity of said tilt sensor is adjustable during manufacture.

15. The system of claim 14, wherein the sensitivity of said tilt sensor is adjusted by the size of the hole.

16. The system of claim 14, wherein the sensitivity of said tilt sensor is adjustable by the size of the ball contact.

17. The system of claim 14, wherein the sensitivity of said tilt sensor is adjustable by the weight of the ball contact.

18. The system of claim 14, wherein the sensitivity of said tilt sensor is adjustable by the conductivity of the ball contact.

19. The system of claim 10, wherein said tilt sensor comprises plural stationary contacts.

20. The system of claim 19, wherein the plural stationary contacts are arranged as pieces of a pie.

21. The system of claim 19, wherein there are 2 stationary contacts.

22. The system of claim 19, wherein there are 4 stationary contacts.

23. The system of claim 19, wherein there are 6 stationary contacts.

24. The system of claim 19, wherein there are 8 stationary contacts.

25. The system of claim 10, wherein said ball contact is a conductive ball.

26. The system of claim 10, wherein the ball contact is gold-plated.

27. The system of claim 10, wherein said stationary contact is gold-plated.

28. The system of claim 1, wherein said motion sensor further includes a housing and said housing is sealed.

29. The system of claim 28, wherein said housing is sealed with an O-ring.

30. The system of claim 28, wherein said housing is sealed with an adhesive.

31. The system of claim 1, wherein said motion sensor comprise an electrical switch and said detection circuit detects a change in state of whether said switch is opened or closed.

32. The system of claim 31, wherein said detection circuit comprises:
a motion detector that determines if there is a change in the opened or closed state of a motion sensor switch; and
a signal processing circuit having a latch circuit that creates a signal of a particular level for a period of time to generate a wake-up signal.

33. The system of claim 32, wherein the motion detector of said detection circuit comprises two invertors for amplifying and converting a motion signal pulse from the motion sensor.

34. The system of claim 32, wherein the motion detector of said detection circuit comprises a single inverter that can detect a low signal from the motion sensor.

35. An input device comprising:
a printed circuit board;
a motion sensor mounted inside the input device on the printed circuit board, said motion sensor having a motion signal output; and
a detection circuit responsive to said motion signal and having a wake-up signal output.

36. A method of waking-up an input device having a printed circuit board inside it, comprising:
mounting a motion sensor directly on said printed circuit board;
outputting a motion signal from said motion sensor;
providing a detection circuit responsive to said motion signal; and
outputting a wake-up signal from said detection circuit to circuitry of said input device to wake-up said input device.

37. The method of claim 36, wherein said input device further comprises a microprocessor and said microprocessor wakes-up the input device in response to said wake-up signal from said detection circuit.
